(19) United States
(12) Patent Application Publication
(10) Pub. No.: US 2025/0287856 A1
(43) Pub. Date: Sep. 18, 2025

(54) AUTONOMOUS ARTICULATING AGRICULTURAL IMPLEMENT CONTROLLERS AND METHODS FOR SAME

(71) Applicant: Raven Industries, Inc., Sioux Falls, SD (US)

(72) Inventors: Brandon Joseph Roth, Parker, SD (US); Matthew K Rust, Chandler, AZ (US); Jared Ernest Kocer, Sioux Falls, SD (US)

(21) Appl. No.: 18/608,237

(22) Filed: Mar. 18, 2024

(51) Int. Cl. A01B 69/00; A01D 34/00

(52) U.S. Cl. CPC A01B 69/004; A01B 69/001; A01D 34/008

(57) ABSTRACT

An autonomous agricultural implement arm system includes a sensor interface, a controller and an actuator interface. The sensor interface is configured for coupling with one or more vision sensors. The one or more vision sensors are directed toward crops and terrain proximate to crops. The controller, in communication with the sensor interface, is configured to identify crops or terrain proximate to crops based on observations of the one or more vision sensors, determine one or more characteristics of the identified crops, and generate implement instructions according to the determined one or more characteristics of the identified crops. The actuator interface, in communication with the controller, is configured to couple with the one or more implement actuators. The actuator interface is configured to relay the implement instructions to the one or more implement actuators for articulation of the agricultural mower implement.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc. of Sioux Falls, South Dakota, USA. All Rights Reserved.

### TECHNICAL FIELD

This document pertains generally, but not by way of limitation, to agricultural implements and control of the same.

### BACKGROUND

Agricultural vehicles are coupled with implements to conduct agricultural operations in fields. In one example, an agricultural mower implement is coupled with a tractor (an example of an agricultural vehicle), and the assembly of the tractor and mower implement are driven through fields to cut crops, such as wheat, grass, alfalfa, or the like. In some examples, the attached implement includes an articulating arm or tongue. In this example, the farmer observes the oncoming crops, for instance, to the left or right of the tractor, and manually controls the articulating arm to position the mower implement on that side of the tractor for mowing.

### OVERVIEW

The present inventors have recognized, among other things, that a problem to be solved can include avoiding automatically positioning a mower (or other implement, such as a swather, windrower or the like, collectively referred to herein as mowers) coupled with a moving tractor in an incorrect location relative to crops because the positioning is based on the travel of the tractor. For instance, in some examples, the implement position is automatically toggled based on the direction of travel or change in the direction of travel, which positions the implement in an orientation without crops or in an orientation that partially cuts a swath (or conducts an operation) instead of cutting an entire swath.

For example, automatic systems that operate an implement provide a controller that positions the implement to interact with forthcoming crops without the manual input of a human operator (in the cab or remotely) to observe crops, position the implement with an articulating arm, and drive the tractor to align the implement with the crops.

These automatic systems do not monitor crops and conduct autonomous articulation and positioning of implements relative to monitored crops. Instead, they are monitoring one or more of position or heading of a tractor and then using the position or heading to prompt the right or left positioning of the implement relative to the tractor. For instance, a tractor mowing alfalfa on its right side while heading west that turns for a proximate swath heads cast. In the automatic system, the implement is articulated to the left side based on this change in the direction of the tractor to mow alfalfa on the left side of the tractor. However, the toggling of sides for the implement based on the direction of travel or change in the direction is agnostic to the actual position of the crop. In other words, the automatic systems are not monitoring crops to control the position of the implement. For instance, a GPS sensor permits the monitoring of a tractor position in a coordinate system. A GPS sensor, however, does not observe crops or determine a crop location (e.g., index the crop location) and fails to permit alignment of the implement with observed and indexed crops. Moreover, a GPS system does not determine characteristics of the identified crops or terrain (e.g., height of crop, stalk height, fruit or head location relative to ground, a height of the terrain, a variety of terrain, a location of the terrain, or the like). Instead, a GPS system and an associated controller are effectively blind with regard to crop position and characteristics and instead control the implement based on the tractor position or movement.

The present subject matter can help provide a solution to this problem, such as by autonomously adjusting the position of the implement based on one or more of crop positions or crop characteristics (including characteristics of the crop itself, terrain, or the like). The systems and methods described herein monitor crops (forthcoming, to the rear, or the like) and conduct autonomous control of an implement to guide the alignment of the implement with the monitored crops. Accordingly, precision agricultural operations, such as mowing, are conducted while errant positioning and control of implements are decreased.

The present subject matter includes but is not limited to the following.

An autonomous agricultural implement system including an implement (e.g., a mower), one or more vision sensors (e.g., an optical sensor, a LiDAR sensor, a radar sensor, a laser sensor, or a camera), a controller, and one or more actuators. The system identifies crops or terrain proximate to the crops and determines characteristics of the identified crops or terrain (e.g., one or more of location, height, type of crop, stalk height, fruit or head location relative to ground, terrain height, terrain contour, terrain type, location or features of the terrain, or the like).

The controller generates implement instructions based on the determined one or more characteristics of the crops or terrain. Based on the generated instructions, the one or more actuators (in communication with the controller) position the implement with respect to one or more of the crops or terrain by autonomously articulating the implement relative to a prime mover and the crops or terrain.

The one or more actuators align the implement by autonomously articulating the implement to guide a portion of the implement, such as an end of the implement, toward or relative to a crop target (e.g., a crop edge or the like). The alignment of the implement also includes, in another example, autonomously adjusting the height of the implement to cut crops at a specified height or elevation, for instance, relative to the terrain. In another example, the alignment of the implement includes adjusting the position (height, lateral position, angle, or the like) of the implement to avoid obstacles.

In other examples, a tractor with a mower articulating arm includes a GPS sensor and a controller. The GPS sensor monitors the location of the tractor, and the controller automatically moves the articulating arm according to the tractor location. For instance, the GPS sensor detects the tractor initially heading cast with the articulating arm on the right side of the tractor. The tractor then conducts an end-of-row turn and heads west for another mowing pass. In this situation, the controller detects the change in orientation or heading (e.g., from east to west) and automatically changes the position of the mower articulating arm to the left side.

This overview is intended to provide a general outline of the subject matter of the present patent application. It is not intended to provide an exclusive or exhaustive explanation of the invention. The Detailed Description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. To easily identify the discussion of any particular element or act, the most significant digit or digits in a reference number refer to the figure number in which that element is first introduced.

FIG. 1 is a perspective view of an example of an agricultural assembly conducting an agricultural operation.

FIG. 2 is a perspective view of one example of an agricultural implement conducting an agricultural operation.

FIG. 3 is a schematic view of one example of an autonomous agricultural implement arm system.

FIG. 4 is a front view of one example of a composite ground profile and crop profile and with a representative agricultural implement.

FIG. 5 is a perspective view of the agricultural assembly of FIG. 1 conducting an agricultural operation with an example of errant coverage.

FIG. 6 is a schematic view of one example of an agricultural field including field based obstacles.

FIG. 7 is a block diagram showing one example of a method for controlling an agricultural mower implement arm.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

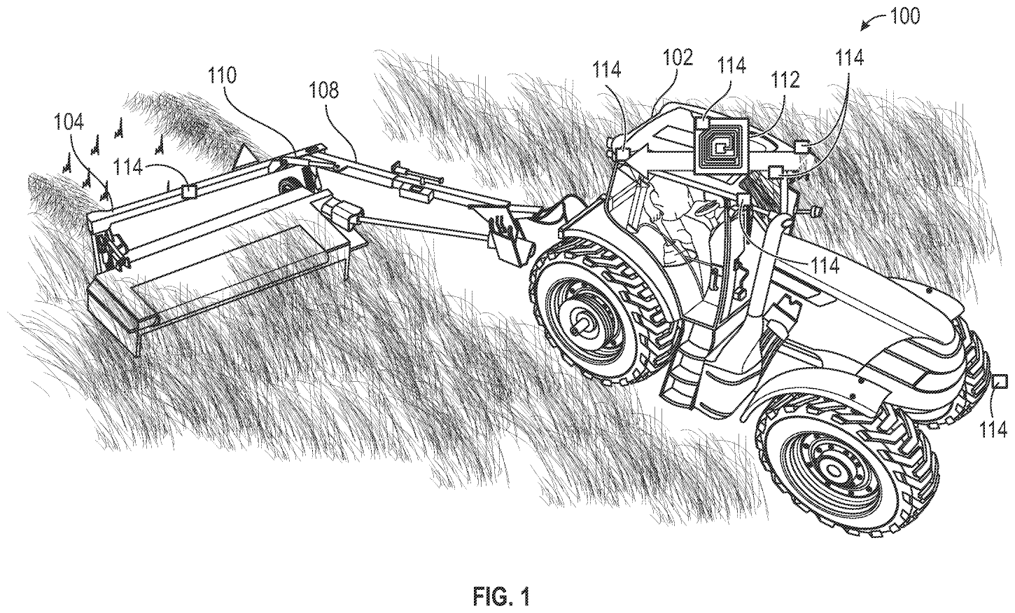

FIG. 1 is an illustration of an agricultural assembly 100 conducting an agricultural operation, in this example, mowing, swathing, reaping, or the like. The agricultural assembly 100 includes an agricultural vehicle such as a prime mover 102 coupled with an agricultural mower implement 104. The prime mover 102 includes, but is not limited to, a tractor or similar. The agricultural mower implement 104 includes, in this example, a mower connected with the prime mover 102 with an articulating arm 108. In other examples, the agricultural mower implement 104 includes, but is not limited to, a mower, a swather, seeder, planter, rake, tiller, cultivator, or the like.

As further shown in FIG. 1, the agricultural assembly 100 includes one or more implement actuators 110 that control associated functions of the agricultural mower implement 104. One example of an implement actuator of the one or more implement actuators 110 includes an arm actuator 208, such as a hydraulic cylinder or cylinders, or the like, that position the agricultural mower implement 104 relative to the prime mover 102. Other example actuators include, but are not limited to, height actuators (e.g., for a sickle height actuator, a reel height actuator, or the like) for controlling cutting height; and motors that drive the implement tools such as sickles, cutting bars or the reel. In other implements, actuators include, but are not limited to, boom height, gang, coulter depth, planting depth, control valves, modulating nozzles, belts, augers, or the like.

The prime mover 102 may be an agricultural vehicle, such as a tractor, combine, harvester or the like.

In operation, an operator for the agricultural assembly 100 having the agricultural mower implement 104 observes forthcoming crops, such as an edge of a crop row, and steers the prime mover 102 to align the connected agricultural mower implement 104 with the edge of the crop row. The operator continues this observation and steering to maintain alignment while conducting the agricultural operation.

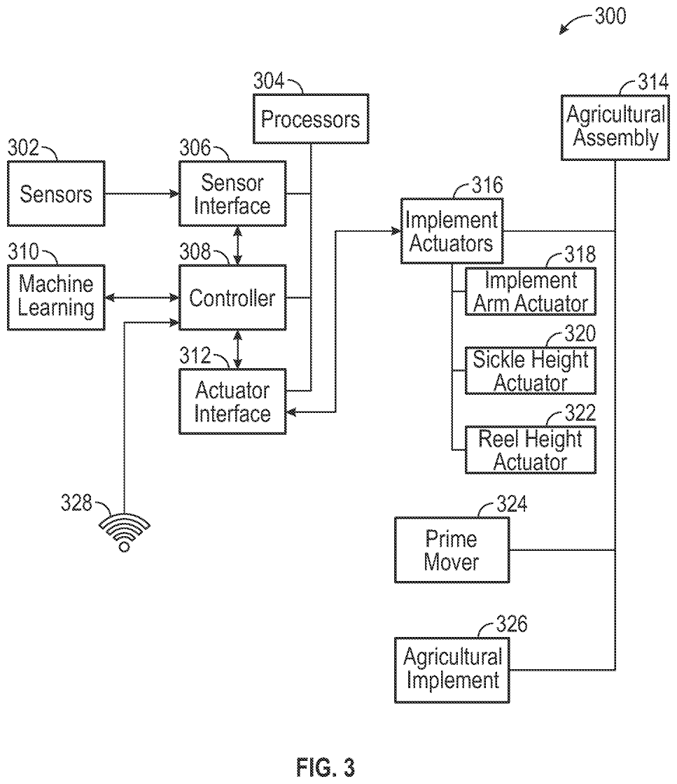

The examples of autonomous agricultural implement arm systems described herein automate the articulation of agricultural mower (e.g., mower, swather, windrower or the like, as well as balers) implement 104, for instance, to guide positioning of the agricultural mower implement 104 relative to observed crops, terrain or the like. In the example shown in FIG. 1, the agricultural assembly 100 includes one or more vision sensors 112 that monitor one or more forthcoming crops, terrain proximate to crops, the region behind agricultural mower implement 104, or the like. As described herein, the one or more vision sensors 112 observe crops, terrain, or the like, and an associated controller 308 (see FIG. 3) of an autonomous agricultural implement arm system 300 identify one or more features from the observations. For instance, the controller 308 identifies crops, terrain, or the like, and facilitates the determination of one or more characteristics of the identified crops or one or more characteristics of the identified terrain. In some instances, the one or more characteristics of the identified crops includes the one or more characteristics of the identified terrain.

In an example, the determined one or more characteristics of the identified crops include a location of a crop target. The controller 308 determines a difference between the position of a crop target (e.g., of a crop edge) and a position of the implement (e.g., an end of the implement 206). The controller 308 implements control of the one or more implement actuators 110, such as an arm actuator coupled with the articulating arm 108, to guide the agricultural mower implement 104 toward the crop target. In one example, guidance includes decreasing the difference between the crop target position and the agricultural mower implement 104, for instance toward a difference of zero. In another example, guidance includes aligning the agricultural mower implement 104, such as an implement end, with the crop edge. The control of the agricultural mower implement 104 is conducted by way of the one or more implement actuators 110 in contrast to (or in addition to) steering of the prime mover 102 as is the case with the operator (farmer) control. The controller 308 and the one or more implement actuators 110 control the articulating arm 108 in cooperation with the one or more vision sensors 112 based on the identified crop (and associated one or more characteristics), terrain, or the like. For instance, the agricultural mower implement 104 is moved with the one or more implement actuators 110 relative to the identified crops instead of the prime mover 102 moving the agricultural mower implement 104.

Additionally, the control of the agricultural mower implement 104 is, in one example, based on identification and analysis of the position of the agricultural mower implement 104 relative to crop target in contrast to gross left or right handed movement of the implement triggered by GPS identified change in direction (e.g., end of row turning, heading changes or the like). Accordingly, as described herein, the agricultural assembly 100 including the autonomous agricultural implement arm system 300 provides accurate control and guidance of the associated agricultural mower implement 104 relative to one or more of the identified crop, terrain or the like.

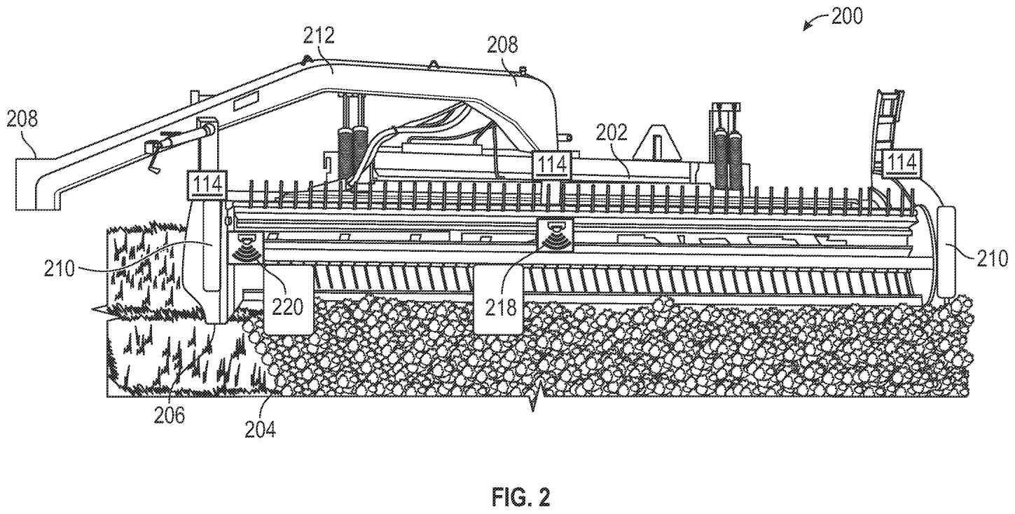

As shown in FIG. 1, the agricultural assembly 100 also includes one or more sensors 114 mounted about the prime mover 102, in one or more examples. The sensors 114 detect operation variables about the prime mover 102 (or other agricultural implements) during the operation of the prime mover 102. In examples, the sensors 114 include at least one of an optical sensor, a LiDAR sensor, a radar sensor, a laser sensor, an ultrasonic height sensor, or a camera. Positioning of the sensors 114 is also shown in FIG. 2, and the operation of the sensors 114 will be discussed with reference to sensors 302 in FIG. 3.

FIG. 2 illustrates an agricultural implement assembly 200 operating a crop in a field. As shown in FIG. 2, the agricultural implement system is used on a hydroswing swather in addition to the mower shown in FIG. 1. The agricultural implement assembly 200 is included with other implements such as, but not limited to, windrowers, swathers (collectively mowers) as well as balers and other autonomous farming implements, or the like. The agricultural implement assembly 200 includes an agricultural implement 202 having an articulating arm 212 and one or more actuators. The agricultural implement assembly 200 optionally includes a prime mover coupled with the agricultural implement 202, for instance with the articulating arm 212.

The one or more actuators include but are not limited to, one or more arm actuators 208, height actuators 210 (e.g., sickle height actuator, reel height actuator, or the like), implement steering actuators, implement tool actuators, or the like. The one or more arm actuators 208 control a side of the agricultural implement 202 that the mower, hydroswing, or the like, follows the tractor during farming operations. In other examples, the arm actuators 208 provide refined control of the position of the agricultural implement 202, for instance to align one or more portions of the implements with specified features of the field, such as a crop, cut crop, windrows or the like. The agricultural implement 202 includes, but is not limited to, a mower, a swather, seeder, planter, rake, tiller, cultivator, or the like. The height actuator 210 is optionally installed on the respective implement and controls the height (e.g., raises, lowers or maintains) of the cycle bars, reels, or other components of the implement, for instance to adjust an elevation of the farming operations.

In an example, the controller 308, shown in FIG. 3, determines a difference between the position of a crop target (e.g., of a crop edge 204) and a position of the agricultural implement 202 (e.g., an end of the implement 206). The controller 308 generates implement instructions according to the determined difference between the location of identified crops and the location of the agricultural implement 202. The controller 308 implements control of the one or more implement actuators, such as an arm actuator 208 coupled with the articulating arm 212, to guide the agricultural implement 202 toward the crop target. In one example, guidance includes decreasing the difference between the position of the crop edge 204 and the end of the implement 206, for instance, guiding the implement position to achieve a difference between positions of zero. In another example, guidance includes aligning the agricultural implement 202, such as an end of the implement 206, with the crop edge 204.

In another example, the controller 308 generates implement instructions according to the crop height, specified cutting or implement tool height, terrain height, obstacles (e.g., rocks, trees, or the like), body of water, or the like. The controller 308 implements control of the one or more implement actuators, such as one or more height actuators 210 coupled with the agricultural implement 202 to control the height of the agricultural implement 202 (e.g., maintain, elevate, lower or the like) in order to, among other things, avoid obstacles or cut the crop at the desired height (e.g. stalk height, fruit or head height relative to ground, or the like).

As discussed herein, the actuators 208 and 210 (and potentially other actuators) are operated with the controller 308 in communication with one or more vision sensors 112. This contrasts with other systems that operate actuators based on vehicle position, heading, or the like. Instead, the controller 308 identifies crops, obstacles, or the like with the vision sensors 112 and actuates the implement based on these identified features. The controller 308 and the one or more implement actuators 208 and 210 control the articulating arm 108 in cooperation with the one or more vision sensors 112 based on the identified crop, terrain, or the like, and the associated one or more characteristics. For instance, the agricultural implement 202 is moved with the one or more implement actuators 208 and 210 based on the identified crops and associated one or more characteristics, or the like, instead of (or in addition to) the agricultural implement 202 being moved based on a prime mover 102 positioning. In another example, controller 308 cooperatively conducts implement control (e.g., position, height, angle, such as pitch, yaw or roll, or the like) with the implement actuators 208 and 210 and the prime mover. For instance, the prime mover provides gross control of the implement to within, as an example, one or two feet of a zone proximate to a target (e.g., crop edge 204 in FIG. 2), and the implement actuators 208 and 210 conduct finer implement positioning toward the target, such as the crop edge 204. As provided herein, the positioning movement with the actuators 208, 210 includes one or more of lateral positioning, elevation or height positioning, angling of the implement (e.g., one or more of pitch, yaw, or roll), or the like.

The control of the agricultural implement 202 is, in one example, based on identification and analysis of the position of the agricultural implement 202 relative to the crop target (difference between the position of the crop target and the position of the agricultural implement 202, average height of identified crop, or the like). This contrasts with gross switching of the agricultural implement 202 to the left or right side relative to the prime mover triggered by GPS identified characteristics of the prime mover 102 (e.g., end of row turning, heading changes, or the like) that is otherwise unaware of crop targets.

One or more sensors 114 are coupled along the agricultural implement 202. In addition to the locations shown in FIG. 1 and FIG. 2, sensors 114 are optionally located in various positions about the agricultural implement 202. For example, the arm actuator 208 includes an arm, post, beam, or other support structure houses or mounts one or more of the sensors 114. In an example, a sensor mount extends from the arm actuator 208 (e.g., over the reels of the agricultural implement 202) and the one or more sensors 114 are directed to monitor the height of the reels during operation of the agricultural implement 202.

FIG. 3 is a schematic diagram of one example of an autonomous agricultural implement arm system 300 for autonomous control of the position of an agricultural implement 326 based on identified crops, terrain, obstacles, or the like, and associated characteristics. The autonomous agricultural implement arm system 300 includes, but is not limited to, sensors 302 (e.g., the one or more sensors 114 shown in FIGS. 1 and 2), one or more processors 304, and an agricultural assembly 314 of the prime mover 324 and the agricultural implement 326 (e.g., an agricultural mower implement). As further shown in FIG. 3, the implement includes one or more implement actuators 316.

The sensors 302, shown in FIG. 3, include, but are not limited to, thermographic camera, forward facing camera, 360 view cameras, radar sensor, LiDAR sensor, laser sensor, optical sensor, or the like, sometimes referred to as vision sensors. Optionally, sensors 302 include other sensor types including implement status sensors, speedometer, GPS, position encoders, or the like. The one or more processors 304 include, but are not limited to, a sensor interface 306 that interconnects the processors 304 with the sensors 302.

As further shown in FIG. 3, the one or more processors 304 include the controller 308 (previously discussed herein), and the controller 308 is interconnected with one or more implement actuators 316 by way of the actuator interface 312. The implement actuators 316 include one or more of the arm actuators 208, height actuators 210, or the like shown in FIG. 2. In the context of FIG. 3, the implement actuators include but are not limited to, one or more of the implement arm actuator 318 (e.g., arm actuator 208 shown in FIG. 2), sickle height actuator 320 (e.g., height actuator 210 shown in FIG. 2), and reel height actuator 322 (e.g., height actuator 210 shown in FIG. 2).

In an example, one or more sensors of the sensors 302 are directed toward crops and terrain proximate to crops. In another example, one or more sensors of the sensors 302 are directed rearward toward crops, such as harvested or treated zones, and terrain proximate to those crops. In an additional example, one or more sensors of the sensors 302 are directed forward of at least one of the prime mover or the agricultural mower implement. In various examples, one or more sensors of the sensors 302 are directed rearward of at least one of the prime mover or the agricultural mower implement. In many other examples, the one or more sensors directed rearward toward crops monitor those crops and proximate terrain that are passed by the agricultural assembly and treated (e.g., mowed, cultivated, sprayed, or the like) or are errantly treated (e.g., not treated or treated improperly). In another example, the one or more sensors directed toward rearward crops detect crops or terrain where the implement operation was conducted by the passing implement, and with the controller 308, identifies errant treatment. Errant treatment includes, in one example, crops that were mowed, harvested, sprayed, cultivated, or the like, errantly. For example, not operated on in a manner consistent with an operation prescription, expected output, or the like. As described herein, the rearward monitoring of crops, terrain, or the like permits the identification of crops that were not acted upon in an expected manner (e.g., were not mowed because of an implement issue, misalignment of the implement, or the like).

The sensors 302 observe one or more of the crops, terrain, vehicle, implement or the like. The controller 308, in FIG. 3, identifies one or more features from the observations. In one embodiment, the sensors 302 are continuously active during the agricultural assembly 314 operation. That is, the sensors 302 are continuously observing crops, terrain, obstacles, status of agricultural operation, completion (or lack thereof) of the agricultural operation, or the like. In one embodiment, the sensors coupled to the sensor interface 306 send observation data to the controller 308 through the sensor interface 306. According to various examples, the controller 308, in communication with the sensor interface 306, includes a machine learning or an artificial intelligence module 310 to associate and compare the observation data to identify crops, terrain, obstacles, or the like and permit determining one or more characteristics of the identified crops, terrain, obstacles, or the like (e.g., an average height of the crops, a terrain height, a variety of the crops, a variety of the terrain, a location of the terrain, or a location of the crops, or the like).

In some examples, the controller 308, using the machine learning or artificial intelligence modules 310 or onboard algorithms, generates implement instructions based on the determined one or more characteristics of the identified crops, terrain, obstacles, or the like. In an example, the generated implement instructions implement position control of the agricultural implement 326 based on the observations of the sensors 302. As shown in FIG. 2, in another example, the controller 308 uses the machine learning module 310 to generate implement instructions according to the location of identified crops, such as the location of a crop target (e.g., a crop edge) and the location of the agricultural implement 326 (e.g., an end of the implement). The controller 308 using the machine learning module 310 determines a difference between the position of a crop target (e.g., of a crop edge) and a position of the agricultural implement 326 (e.g., an end of the implement). In this example, the implement instructions include guiding the agricultural implement 326 to decrease the determined difference. In an additional example, with detection of crops mowed errantly rearward of the agricultural implement 326, the controller 308 positions the agricultural implement 326 to overlay that portion of the field and thereby mow forthcoming crops that the implement would otherwise miss. The control instructions are generated by the controller 308 with one or more of feedback control to decrease observed error (e.g., crops mowed, harvested, sprayed, cultivated, or the like, errantly, including failure to do the same).

In various examples, the controller 308 generates implement instructions according to one or more determined characteristics including, but not limited to, the crop height, terrain height, terrain contour, obstacle height or profile (e.g., rocks, trees, or the like), or the like. The controller 308, for instance, having a machine learning module 310, calculates an average height based on one or more characteristics of the identified crops, terrain, obstacles, or the like. In an example, the controller 308 using the machine learning module 310 determines the one or more characteristics of the identified crops, terrain, obstacles, or the like in an ongoing manner (e.g., continuously, based on a frequency, or the like) as the agricultural assembly 100 moves. In this manner, characteristics such as average height, profile, contour, or the like are updated to associate control with the present conditions in the field. In one example, the implement instructions include adjusting the height of the agricultural implement 202 to a determined average height in order to, among other things, avoid obstacles, cut the crop to a specified height (e.g. stalk height, fruit or head height relative to ground, or the like).

The controller 308 implements control of the one or more implement actuators, such as an implement arm actuator 318 coupled with the agricultural implement 326, to guide the positioning of the agricultural implement 326. In one example, the controller 308 sends control signals including the generated implement instructions including, but not limited to, laterally moving right or left, inward or outward the agricultural implement 326 by 1 inch per second until the determined difference is zero, adjust the height of the agricultural implement 326 by 1 inch per second up to the average height, angle the implement by 3 degrees per second for one or more of pitch, yaw or roll or the like) to the one or more implement actuators 316. In an example, the control signals are transmitted through the actuator interface 312 and are parsed out to the appropriate actuators, for instance, alignment implement instructions to decrease the determined difference are delivered to the implement arm actuator 318; implement instructions to adjust height are delivered to the sickle height actuator 320 or reel height actuator 322; implement instructions to adjust angle are delivered to pivot or tilt actuators (potentially a component of the actuators 318, 320) or the like.

In some examples, the actuator interface 312 in communication with the controller 308 is configured to relay the implement instructions to the one or more implement actuators 316 for articulation of the agricultural implement 326. In an example, the agricultural implement 326 includes, but is not limited to, a mower, a swather, seeder, planter, rake, tiller, cultivator, sprayer, or the like.

Accordingly, as described herein, the autonomous agricultural implement arm system 300 provides accurate control and guidance of the associated implement relative to one or more of the identified crops, terrain, or the like, in lieu of (or in addition to) switching the agricultural implement 202 to the left or right side relative to the prime mover 324 triggered by GPS identified change in direction of the prime mover 324 (e.g., end of row turning, heading changes or the like). The autonomous agricultural implement arm system 300 permits the accurate guidance of implements relative to targets such as crop targets, terrain targets, or the like including associated characteristics of the same.

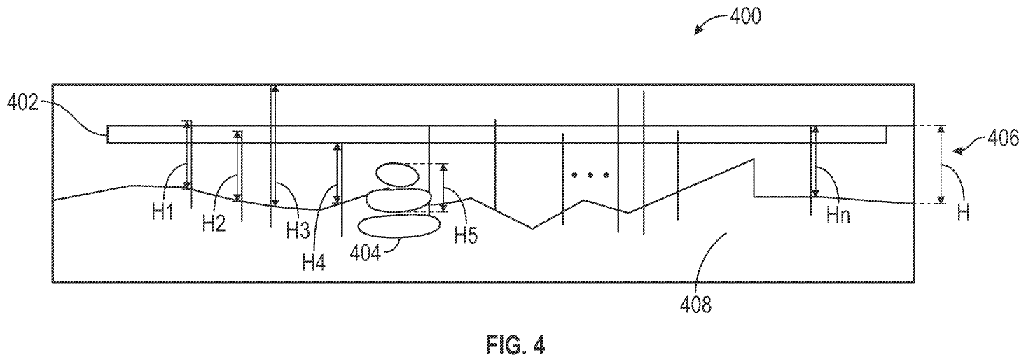

FIG. 4 is a schematic illustration of an autonomous agricultural implement arm system 400 and a terrain profile 408. The autonomous agricultural implement arm system 400 adjusts the height of an agricultural implement 402 during an agricultural operation, for instance relative to the terrain profile 408, crops, or the like. In an example, the sensors 302, shown in FIG. 3, sense crops, terrain, obstacles, or the like, and one or more associated characteristics are determined (e.g., observed, calculated, identified from the sensory information, or the like). The associated one or more characteristics of the identified crops, terrain, or the like include, but are not limited to, crop height, terrain height, terrain contour, stalk height, obstacle height, or the like. As shown in FIG. 2 and discussed herein, in an example, the controller 308, in communication with the sensor interface 306, generates implement instructions according to one or more of the crop height, terrain height, obstacle height (e.g., rocks trees, sensed unidentified objects, or the like), profiles (e.g., contours) of the same, or the like.

The controller 308, for example, calculates an average height 406 based on the associated one or more characteristics of the crops, terrain, or the like. In an example, the controller 308 determines one or more characteristics of the identified crops (e.g., height, profile, or the like) in an ongoing manner. For instance, as the agricultural assembly 314 moves in the field. In other examples, the controller 308 determines one or more characteristics including height, average height, lowest cuttable height without obstacle collision, profile, contour, or the like, and one or more of these characteristics are inputs for the generation of implement instructions by the controller 308. The controller 308 sends the implement instructions to one or more implement actuators through an actuator interface 312 (see FIG. 3). In one example, the height actuator 210 (e.g., 320, 322 in FIG. 3) is coupled with the agricultural implement 402 and control instructions are sent to the height actuator 210 to guide the agricultural implement 402 to a specified height. For instance, the height of the agricultural implement 402 is adjusted to the calculated average height 406 (or other specified value, such as lowest cuttable height without obstacle collision, or the like) to avoid obstacles, cut the crop to a specified height (e.g. stalk height, fruit or head height relative to ground), or the like.

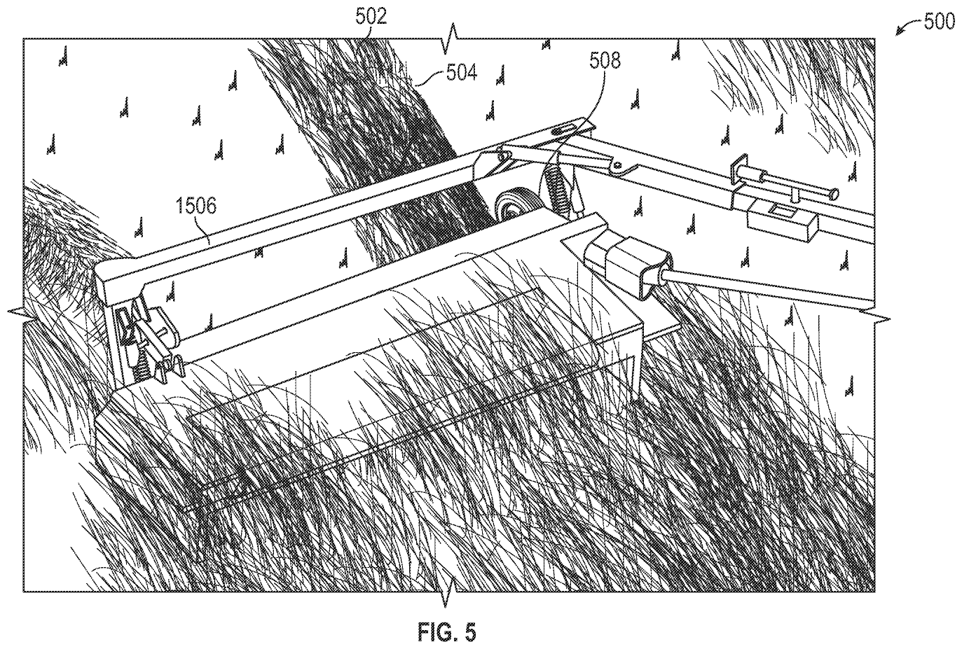

FIG. 5, is a perspective illustration of an autonomous agricultural implement arm system 500 during an agricultural operation, according to one embodiment. In FIG. 5, one or more vision sensors (302 in FIG. 3, and 218, 220 in FIG. 2) are facing rearward relative to the agricultural implement 506. The one or more rearward facing vision sensors observe the crops, terrain, or the like, behind the agricultural implement 506. In various examples, the controller 308, in communication with the sensors 302 (e.g., with the sensor interface 306 shown in FIG. 3), is configured to identify errantly treated crops 502 or terrain (e.g., not treated or treated improperly) and generate implement instructions to adjust the agricultural implement location to address the error. Optionally, the controller 308 includes or communicates with a machine learning module 310 that identifies errantly treated crops 502 or terrain to facilitate generation of implement instructions.

In other examples, the controller 308, optionally in communication with a machine learning module 310, calculates a difference between a position of an errantly mowed crop edge 504 and a position of an implement end 508 and generates implement instructions based on the calculated difference. The implement instructions include but are not limited to instructions to move the agricultural implement 506 (e.g., an angle, a distance, speed such as by an inch per second, or the like) until the implement end 508 coincides with or proximates to the crop edge 504. More specifically, the implement instructions include, for example, moving the agricultural implement 506 until the calculated difference between the position of the crop edge 504 and the position of the implement end 508 approaches (or reaches) zero.

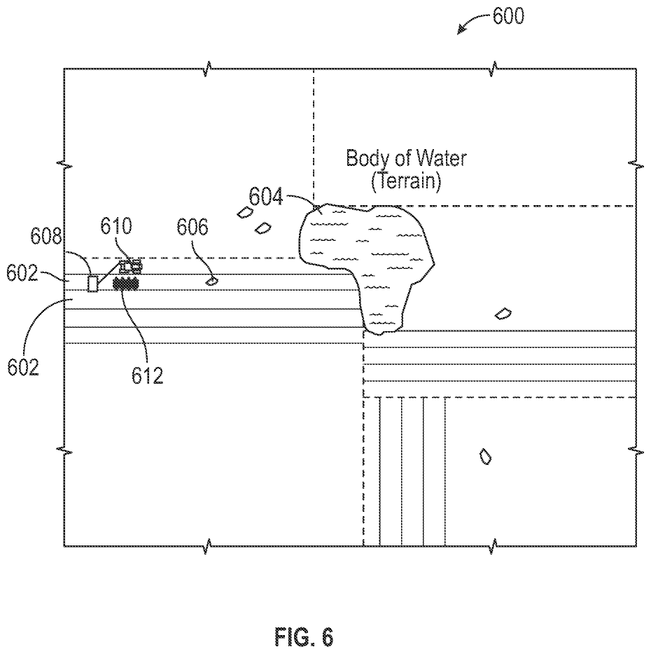

FIG. 6 illustrates an exemplary agricultural field 600 with the agricultural assembly having an agricultural implement 608 and a prime mover 610 conducting an operation in the field. In various examples, the sensors 302 shown in FIG. 3, observe crops, terrain, obstacles, or the like, and the controller determines or identifies one or more associated characteristics. Referring back to FIG. 6, the associated one or more characteristics of the identified crops 612, terrain 614, obstacles 606 (e.g., such as a body of water 604, rocks, livestock, humans, vehicles, fences, ditches, trees, or the like, include but are not limited to, an average height of the crops, a terrain height, a terrain contour, a variety of the crops, a variety of the terrain, a location of the terrain, a location of the body of water, a location of the crops, or the like. As shown in FIG. 3, the sensors 302 coupled to the sensor interface 306 send observation data to the controller 308 optionally through the sensor interface 306. The controller 308 identifies crops, terrain, obstacles, or the like, and one or more associated characteristics based on the observation data and, accordingly, generates implement instructions to adjust the positioning (height, lateral position, angle such as yaw, pitch or roll, or the like) of the agricultural implement 608.

In various examples, the autonomous agricultural implement arm system (e.g., 300, 400, and 500) receives or includes a mission, for instance through an input 328 shown in FIG. 3. The input 328 includes, but is not limited, a data port (USB port), keyboard, transceiver (wifi, cellular, radio or the like) configured to receive and optionally transmit data, such as a mission package of instructions. In an example, the controller 308 identifies headings, swaths, A-B lines, waypoints, turns or the like for the prime mover 610. In another example, the controller 308 determines the side (or handedness, left or right) of the agricultural implement 608 including having the implement 608 on either of the left or right side of the prime mover 610 based on the mission parameters. For example, the controller 308 detects arrival of the prime mover 610 at or proximate to the end of a mowing swath 602 and turns (e.g., with an automated turn) to the next mowing swath 602. The controller 308, shown in FIG. 3, implementing the mission, is configured to generate implement instructions to adjust the agricultural implement 608 location according to the heading, swath, change in heading or swath, or the like of the prime mover 610 (e.g., turning to the next mowing swath 602, or the like). The controller 308 in combination with the sensors 302 and actuators 316 (in FIG. 3) provide a fine control of the implement to guide the implement position, for instance into alignment with the forthcoming crops, to ensure accurate conduct of the mowing operation.

In other examples, controller 308, shown in FIG. 3, is configured to generate implement instructions to shift the agricultural implement 608 position (e.g., from one side to the other, or the like) when the prime mover 610 turns around in the opposite direction. For example, the controller 308 automatically toggles the implement position from left to right, right to left, or the like, relative to the prime mover 610 based on the heading or change in heading of the prime mover 610. In another example, the controller 308 provides a gross form of control that positions the implement 608 to the left or right based on detection of forthcoming crops to the right or left of the prime mover 610. The controller 308 further provides the fine control of the implement 608 to align and orient the implement 608 to the forthcoming crops and ensure accurate conduct of the mowing operation (e.g., decreasing mowing errors, avoiding obstacles or the like).

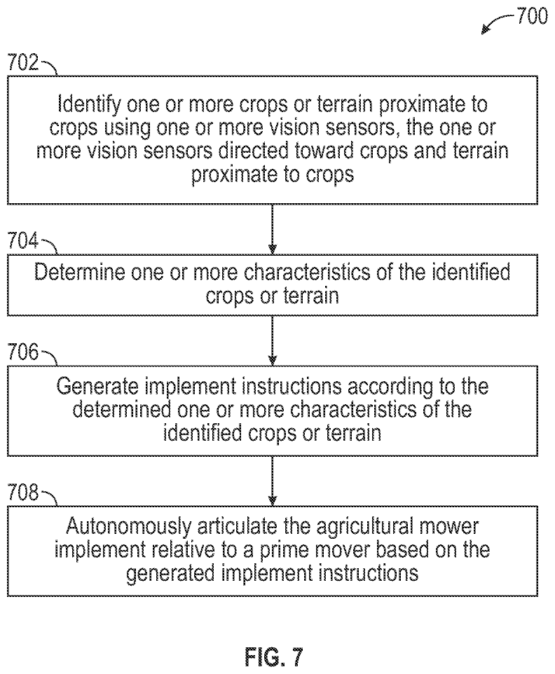

FIG. 7 is a block diagram including one example of a method 700 for autonomously articulating an agricultural mower arm implement, such as the agricultural implement assembly 200, shown in FIG. 2. In describing the method 700, reference is made to one or more components, features, functions, steps, or the like previously described herein. Where convenient, reference is made to the components, features, functions, steps, or the like with reference numerals. Reference numerals provided are exemplary and are not exclusive. For instance, components, features, functions, steps, or the like described in method 700 include, but are not limited to, corresponding numbered elements provided herein, other corresponding features described herein (both numbered and unnumbered), as well as their equivalents.

In block 702, the method 700 includes identification of one or more crops or terrain proximate to crops using one or more sensors, in an example, the sensors 302 (FIG. 3) include one or more vision sensors directed toward crops and terrain proximate to crops. The vision sensors 302 in block 702 are activated and begin the process of observing crops, terrain, obstacles, or the like in an ongoing manner as the agricultural assembly conducts an agricultural operation.

In block 704, the method 700 includes determining one or more characteristics of the identified crops or terrain (e.g., crop height, stalk height, fruit or head location relative to ground, a height of the terrain, a variety of terrain, terrain contour, a location of the terrain, obstacles, obstacle height, or the like). Controller 308, shown in FIG. 3 identifies one or more of crops, terrain, obstacles, or the like, and associated characteristics based on observation data provided by the one or more vision sensors 302. As described herein, the controller 308 optionally includes or is in communication with a machine learning module configured to identify crops, terrain, obstacles, or the like including associated characteristics for the same.

In block 706, the method 700 generates implement instructions according to the determined one or more characteristics of the identified crops, terrain, or the like. For example, the controller 308 generates implement instructions for actuation of the implement.

In block 708, the method 700 autonomously articulates the agricultural mower implement 104 (in FIG. 1) relative to a prime mover 102 (e.g., a tractor) based on the generated implement instructions. As described herein, articulation includes but is not limited to guidance of the implement 104 to decrease errant agricultural operations. For example, the controller 308, vision sensors 302 and implement actuators 316 (see FIG. 3) cooperatively control the implement 104 to align the implement with observed forthcoming crops. Additionally, in other examples, the controller 308 observes output of the agricultural implement 326 (shown in FIG. 3) by observing in the rear direction to detect and identify errantly treated or not treated crops, terrain, or the like, such as missed crops, misapplied agricultural products, or the like.

Several options for the method 700 follow. In one example, the method 700 includes the one or more vision sensors directed toward terrain beneath crops, for instance to monitor terrain height, terrain contour, detect obstacles and permit identification of characteristics of the detected obstacles. In another example, the one or more vision sensors include at least one of an optical sensor, a LiDAR sensor, a radar sensor, a laser sensor, or a camera.

In other examples, the one or more vision sensors directed toward crops and terrain proximate to crops includes at least one of an agricultural mower implement arm sensor (e.g., 220 in FIG. 2), a sickle height sensor (e.g., 218 in FIG. 2), or a reel height sensor (e.g., 218 in FIG. 2).

In various examples, at least one of the one or more vision sensors is directed forward (e.g., 112 in FIG. 1) of at least one of the prime mover (e.g., 102 in FIG. 1) or the agricultural mower implement (e.g., 104 in FIG. 1, 326 in FIG. 3, 402 in FIG. 4, 506 in FIG. 5, 608 in FIG. 6). In additional examples, at least one of the one or more vision sensors is directed rearward (e.g., 220 in FIG. 2) of at least one of the prime mover (e.g., 102 in FIG. 1) or the agricultural mower implement (e.g., 202 in FIG. 2).

In various examples, method 700 includes detecting, with the at least one of the one or more vision sensor directed reward (e.g., 220 in FIG. 2), crops mowed errantly (e.g., 502 in FIG. 5) located behind the agricultural mower implement (e.g., 104 in FIG. 1, 326 in FIG. 3, 402 in FIG. 4, 506 in FIG. 5, 608 in FIG. 6).

In another example, the one or more characteristics of the identified crops includes at least one of an average height of the crops, a terrain height, a variety of the crops, a variety of the terrain, terrain contour, obstacle identification, or a location of the crops. In various examples, the one or more characteristics of the identified crops includes an alignment determination between a crop edge (e.g., 204 in FIG. 2) and a cutting end of the agricultural mower implement (e.g., 206 in FIG. 2). In an additional example, the one or more characteristics of the identified crops include a location of the crops and the method 700 includes determining a difference between the location of the crops and a location of the agricultural mower implement 104 (shown in FIG. 1).

In various examples, the method 700 further includes generating implement instructions including implement instructions for articulating the agricultural mower implement 104 to decrease the difference (e.g. until the difference approaches or reaches zero). In various examples, determining the difference between the location of the crops and a location of the agricultural mower implement (e.g., 104 in FIG. 1) includes determining a difference between a crop edge (e.g., 204 in FIG. 2) and a cutting end of the agricultural mower implement (e.g., 206 in FIG. 2). In other examples, the method 700 further includes generating implement instructions based on the alignment determination between a crop edge (e.g., 204 in FIG. 2) and a cutting end of the agricultural mower implement (e.g., 206 in FIG. 2).

In various examples, the method 700 includes autonomously controlling a sickle height of a sickle coupled to the agricultural mower implement (e.g. 104 in FIG. 1, 202 in FIG. 2). In an additional example, controlling the sickle height is based on at least one of the average height of the crops, the terrain height, the variety of the crops, or the variety of the terrain.

In various examples, the method 700 includes a remote operator overriding the implement instructions. In various examples, identifying terrain proximate to crops includes an obstacle recognition. In another example, the method 700 includes generating implement instructions based on the obstacle recognition. In other examples, the implement instructions includes instructions to autonomously adjust height of the agricultural mower implement (e.g., 202 in FIG. 2) based on the obstacle recognition.

The above description includes references to the accompanying drawings, which form a part of the Detailed Description. The drawings show, by way of illustration, specific embodiments in which the invention can be practiced. These embodiments are also referred to herein as “aspects” or “examples.” Such aspects or examples can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The following, non-limiting examples, detail certain aspects of the present subject matter to solve the challenges and provide the benefits discussed herein, among others.

Example 1 is an autonomous agricultural implement arm system comprising: one or more implement actuators configured to articulate an agricultural mower implement relative to a prime mover; one or more processors configured to control actuation of the one or more implement actuators, the one or more processors include: a sensor interface configured for coupling with one or more vision sensors, the one or more vision sensors directed toward crops and terrain proximate to crops; a controller in communication with the sensor interface, the controller is configured to: identify crops or terrain proximate to crops based on observations of the one or more vision sensors; determine one or more characteristics of the identified crops; and generate implement instructions according to the determined one or more characteristics of the identified crops; and an actuator interface in communication with the controller, the actuator interface configured to couple with the one or more implement actuators, wherein the actuator interface is configured to relay the implement instructions to the one or more implement actuators for articulation of the agricultural mower implement.

In Example 2, the subject matter of Example 1 includes, wherein the one or more vision sensors directed toward crops and terrain proximate to crops includes one or more vision sensors directed toward terrain beneath crops.

In Example 3, the subject matter of Examples 1-2 includes, wherein the one or more vision sensors directed toward crops and terrain proximate to crops includes at least one of an optical sensor, a LiDAR sensor, a radar sensor, a laser sensor, or a camera.

In Example 4, the subject matter of Examples 1-3 includes, wherein at least one implement actuator of the one or more implement actuators includes an implement arm actuator coupled with an articulating arm, the implement arm actuator configured to move the agricultural mower implement relative to the prime mover with the articulating arm.

In Example 5, the subject matter of Example 4 includes, the articulating arm configured for coupling between the agricultural mower implement and the prime mover.

In Example 6, the subject matter of Examples 1-5 includes, wherein the one or more characteristics of the identified crops include a location of the crops; comprising determining a difference between the location of the crops and a location of the agricultural mower implement; and wherein the generated implement instructions include implement instructions for articulating the agricultural mower implement to decrease the difference.

In Example 7, the subject matter of Example 6 includes, wherein determining the difference includes determining a difference between a crop edge and a cutting end of the agricultural mower implement.

In Example 8, the subject matter of Examples 1-7 includes, wherein the one or more implement actuators includes at least one of a sickle height actuator or a reel height actuator.

In Example 9, the subject matter of Examples 1-8 includes, wherein the one or more characteristics of the identified crops includes at least one of an average height of the crops, a terrain height, a variety of the crops, a variety of the terrain, a location of the terrain, or a location of the crops.

In Example 10, the subject matter of Examples 8-9 includes, wherein the sickle height actuator is configured to adjust the height of a sickle coupled to the implement based on at least one of an average height of the crops, a terrain height, a variety of the crops, or a variety of the terrain.

In Example 11, the subject matter of Examples 1-10 includes, wherein a remote operator may override the implement instructions.

In Example 12, the subject matter of Examples 1-11 includes, wherein the one or more characteristics of the identified crops includes an alignment determination between a crop edge and a cutting end of the agricultural mower implement.

In Example 13, the subject matter of Example 12 includes, generate implement instructions based on the alignment determination.

In Example 14, the subject matter of Examples 1-13 includes, wherein identifying terrain proximate to crops includes an obstacle recognition.

In Example 15, the subject matter of Example 14 includes, wherein the controller, in communication with the sensor interface, is further configured to: generate implement instructions based on the obstacle recognition, the implement instructions including instructions to autonomously adjust height of the implement.

In Example 16, the subject matter of Examples 1-15 includes, wherein the one or more vision sensors directed toward crops and terrain proximate to crops includes at least one of an implement arm sensor, a sickle height sensor, or a reel height sensor.

In Example 17, the subject matter of Examples 1-16 includes, wherein at least one of the one or more vision sensors is directed forward of at least one of the prime mover or the implement.

In Example 18, the subject matter of Examples 1-17 includes, wherein at least one of the one or more vision sensors is directed rearward of at least one of the prime mover or the implement.

Example 19 is an autonomous agricultural implement arm system comprising: one or more implement actuators configured to articulate an agricultural mower implement relative to a prime mover; and one or more processors configured to control actuation of the one or more implement actuators, the one or more processors include: a sensor interface configured for coupling with one or more vision sensors directed toward crops; a controller, in communication with the sensor interface, the controller is configured to: identify crops based on observations of the one or more vision sensors; determine a location of the identified crops; and generate implement instructions based on the determined location of the identified crops; and an actuator interface, in communication with the controller, the actuator interface configured to couple with the one or more implement actuators, wherein the actuator interface is configured to relay the implement instructions to the one or more implement actuators for articulation of the agricultural mower implement.

In Example 20, the subject matter of Example 19 includes, wherein the one or more vision sensors directed toward crops includes at least one of an optical sensor, a LiDAR sensor, a radar sensor, a laser sensor, or a camera.

In Example 21, the subject matter of Examples 19-20 includes, wherein the one or more vision sensors directed toward crops includes at least one of a vision sensor directed toward terrain proximate to crops or a vision sensor directed toward terrain beneath crops.

In Example 22, the subject matter of Examples 19-21 includes, wherein at least one implement actuator of the one or more implement actuators includes an implement arm actuator coupled with an articulating arm, the implement arm actuator configured to move the agricultural mower implement relative to the prime mover with the articulating arm.

In Example 23, the subject matter of Example 22 includes, the articulating arm configured for coupling between the agricultural mower implement and the prime mover.

In Example 24, the subject matter of Examples 19-23 includes, determine a difference between the location of the identified crops and a location of the agricultural mower implement; and wherein the generated implement instructions include implement instructions for articulating the agricultural mower implement to decrease the difference.

In Example 25, the subject matter of Example 24 includes, wherein determining the difference includes determining a difference between a crop edge and a cutting end of the agricultural mower implement.

In Example 26, the subject matter of Examples 19-25 includes, wherein the one or more implement actuators includes at least one of a sickle height actuator or a reel height actuator.

In Example 27, the subject matter of Examples 19-26 includes, wherein at least one of the one or more vision sensors directed toward crops are directed rearward of at least one of the prime mover or the agricultural mower implement.

In Example 28, the subject matter of Examples 19-27 includes, wherein at least one of the one or more vision sensors directed toward crops is directed forward of at least one of the prime mover or the agricultural mower implement.

In Example 29, the subject matter of Examples 19-28 includes, wherein the controller, in communication with the sensor interface, is further configured to: identify one or more terrain proximate to crops; and determine one or more characteristics of the identified crops.

In Example 30, the subject matter of Example 29 includes, wherein the one or more characteristics of the identified crops includes at least one of an average height of the crops, a terrain height, a variety of the crops, a variety of the terrain, or a location of the terrain.

In Example 31, the subject matter of Example 30 includes, wherein the one or more implement actuators includes at least one of a sickle height actuator; and wherein the sickle height actuator is configured to control a sickle height of a sickle coupled to the agricultural mower implement based on at least one of the average height of the crops, the terrain height, the variety of the crops, or the variety of the terrain.

In Example 32, the subject matter of Examples 29-31 includes, wherein the one or more characteristics of the identified crops include an obstacle recognition.

In Example 33, the subject matter of Example 32 includes, wherein the controller, in communication with the sensor interface, is further configured to: generate implement instructions based on the obstacle recognition, the implement instructions including instructions to autonomously adjust height of the agricultural mower.

In Example 34, the subject matter of Examples 19-33 includes, wherein a remote operator may override the implement instructions.

In Example 35, the subject matter of Examples 19-34 includes, wherein the location of the identified crops includes an alignment determination between a crop edge and a cutting end of the agricultural mower implement.

In Example 36, the subject matter of Example 35 includes, wherein the controller, in communication with the sensor interface, is further configured to: generate implement instructions based on the alignment determination.

In Example 37, the subject matter of Examples 21-36 includes, wherein the one or more vision sensors directed toward crops and terrain proximate to crops includes at least one of an implement arm sensor, a sickle height sensor, or a reel height sensor.

Example 38 is a method for autonomously articulating an agricultural mower implement arm of an agricultural mower implement comprising: identifying one or more crops or terrain proximate to crops using one or more vision sensors, the one or more vision sensors directed toward crops and terrain proximate to crops; determining one or more characteristics of the identified crops; generating implement instructions according to the determined one or more characteristics of the identified crops; and autonomously articulating the agricultural mower implement relative to a prime mover based on the generated implement instructions.

In Example 39, the subject matter of Example 38 includes, wherein the one or more vision sensors directed toward crops and terrain proximate to crops includes one or more vision sensors directed toward terrain beneath crops.

In Example 40, the subject matter of Examples 38-39 includes, wherein the one or more vision sensors directed toward crops and terrain proximate to crops includes at least one of an optical sensor, a LiDAR sensor, a radar sensor, a laser sensor, or a camera.

In Example 41, the subject matter of Examples 38-40 includes, wherein the one or more characteristics of the identified crops includes at least one of an average height of the crops, a terrain height, a variety of the crops, a variety of the terrain, obstacle identification, or a location of the crops.

In Example 42, the subject matter of Examples 38-41 includes, wherein the one or more characteristics of the identified crops include a location of the crops; comprising determining a difference between the location of the crops and a location of the agricultural mower implement; and wherein the generated implement instructions include implement instructions for articulating the agricultural mower implement to decrease the difference.

In Example 43, the subject matter of Example 42 includes, wherein determining the difference includes determining a difference between a crop edge and a cutting end of the agricultural mower implement.

In Example 44, the subject matter of Example 43 includes, autonomously controlling a sickle height of a sickle coupled with the agricultural mower implement, controlling the sickle height is based on at least one of the one or more characteristics of the identified crops, the one or more characteristics of the identified crops including an average height of the crops, a terrain height, a variety of the crops, or a variety of the terrain.

In Example 45, the subject matter of Examples 43-44 includes, a remote operator overriding the implement instructions.

In Example 46, the subject matter of Examples 38-45 includes, wherein the one or more characteristics of the identified crops or terrain includes an alignment determination between a crop edge and a cutting end of the agricultural mower implement.

In Example 47, the subject matter of Example 46 includes, generating implement instructions based on the alignment determination.

In Example 48, the subject matter of Examples 38-47 includes, wherein identifying terrain proximate to crops includes an obstacle recognition.

In Example 49, the subject matter of Example 48 includes, generating implement instructions based on the obstacle recognition, the implement instructions including instructions to autonomously adjust height of the agricultural mower implement.

In Example 50, the subject matter of Examples 39-49 includes, wherein the one or more vision sensors directed toward crops and terrain proximate to crops includes at least one of an agricultural mower implement arm sensor, a sickle height sensor, or a reel height sensor.

In Example 51, the subject matter of Examples 39-50 includes, wherein at least one of the one or more vision sensors is directed forward of at least one of the prime mover or the agricultural mower implement.

In Example 52, the subject matter of Examples 38-51 includes, wherein at least one of the one or more vision sensors is directed rearward of at least one of the prime mover or the agricultural mower implement.

In Example 53, the subject matter of Example 52 includes, detecting, with the at least one of the one or more vision sensor directed reward, crops mowed errantly located behind the agricultural mower implement.

Example 54 is at least one machine-readable medium including instructions that, when executed by processing circuitry, cause the processing circuitry to perform operations to implement of any of Examples 1-53.

Example 55 is an apparatus comprising means to implement of any of Examples 1-53.

Example 56 is a system to implement of any of Examples 1-53.

Example 57 is a method to implement of any of Examples 1-53.

Each of these non-limiting aspects can stand on its own, or can be combined in various permutations or combinations with one or more of the other aspects.

The above description includes references to the accompanying drawings, which form a part of the Detailed Description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part, for instance with one or more processors, associated memory, input and output devices. Some aspects or examples can include a computer-readable medium or machine-readable medium encoded with instructions operable to configure an electronic device to perform methods as described in the above aspects or examples. An implementation of such methods can include code, circuits, code modules, software modules, hardware modules or the like, such as or having microcode, assembly language code, a higher-level language code, hardwiring or the like. Such code can include computer readable instructions for performing various methods. The code may form portions of computer program products or is included in controllers, programmable logic controllers or the like having modules (e.g., circuits, software, subunits or the like) configured to implement the code and perform the various methods. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), circuits and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An autonomous agricultural implement arm system comprising:
one or more implement actuators configured to articulate an agricultural mower implement relative to a prime mover; and
one or more processors configured to control actuation of the one or more implement actuators, the one or more processors include:
a sensor interface configured for coupling with one or more vision sensors, the one or more vision sensors directed toward crops and terrain proximate to crops;
a controller in communication with the sensor interface, the controller is configured to:
identify crops or terrain proximate to crops based on observations of the one or more vision sensors;
determine one or more characteristics of the identified crops; and
generate implement instructions according to the determined one or more characteristics of the identified crops; and
an actuator interface in communication with the controller, the actuator interface configured to couple with the one or more implement actuators, wherein the actuator interface is configured to relay the implement instructions to the one or more implement actuators for articulation of the agricultural mower implement.

2. The implement arm system of claim 1, wherein the one or more vision sensors directed toward crops and terrain proximate to crops includes one or more vision sensors directed toward terrain beneath crops.

3. The implement arm system of claim 1, wherein the one or more vision sensors directed toward crops and terrain proximate to crops includes at least one of an optical sensor, a LiDAR sensor, a radar sensor, a laser sensor, or a camera.

4. The implement arm system of claim 1, wherein at least one implement actuator of the one or more implement actuators includes an implement arm actuator coupled with an articulating arm, the implement arm actuator configured to move the agricultural mower implement relative to the prime mover with the articulating arm.

5. The implement arm system of claim 4, further comprising:
the articulating arm configured for coupling between the agricultural mower implement and the prime mover.

6. The implement arm system of claim 1, wherein the one or more characteristics of the identified crops include a location of the crops, wherein the location of the crops comprises:
determining a difference between the location of the crops and a location of the agricultural mower implement; and
wherein the generated implement instructions include implement instructions for articulating the agricultural mower implement to decrease the difference.

7. The implement arm system of claim 6, wherein determining the difference includes determining a difference between a crop edge and a cutting end of the agricultural mower implement.

8. The implement arm system of claim 1, wherein the one or more implement actuators includes at least one of a sickle height actuator or a reel height actuator.

9. The implement arm system of claim 1, wherein the one or more characteristics of the identified crops includes at least one of an average height of the crops, a terrain height, a variety of the crops, a variety of the terrain, a location of the terrain, or a location of the crops.

10. The implement arm system of claim 8, wherein the sickle height actuator is configured to adjust the height of a sickle coupled to the implement based on at least one of an average height of the crops, a terrain height, a variety of the crops, or a variety of the terrain.

11. The implement arm system of claim 1, wherein a remote operator may override the implement instructions.

12. The implement arm system of claim 1, wherein the one or more characteristics of the identified crops includes an alignment determination between a crop edge and a cutting end of the agricultural mower implement.

13. The implement arm system of claim 12, further comprising:
generate implement instructions based on the alignment determination.

14. The implement arm system of claim 1, wherein identifying terrain proximate to crops includes an obstacle recognition.

15. The implement arm system of claim 14, wherein the controller, in communication with the sensor interface, is further configured to:
generate implement instructions based on the obstacle recognition, the implement instructions including instructions to autonomously adjust height of the implement.

16. The implement arm system of claim 1, wherein the one or more vision sensors directed toward crops and terrain proximate to crops includes at least one of an implement arm sensor, a sickle height sensor, or a reel height sensor.

17. The implement arm system of claim 1, wherein at least one of the one or more vision sensors is directed forward of at least one of the prime mover or the implement.

18. The implement arm system of claim 1, wherein at least one of the one or more vision sensors is directed rearward of at least one of the prime mover or the implement.

19. An autonomous agricultural implement arm system comprising:
one or more implement actuators configured to articulate an agricultural mower implement relative to a prime mover; and
one or more processors configured to control actuation of the one or more implement actuators, the one or more processors include:
a sensor interface configured for coupling with one or more vision sensors directed toward crops;
a controller, in communication with the sensor interface, the controller is configured to:
identify crops based on observations of the one or more vision sensors;
determine a location of the identified crops; and
generate implement instructions based on the determined location of the identified crops; and
an actuator interface, in communication with the controller, the actuator interface configured to couple with the one or more implement actuators, wherein the actuator interface is configured to relay the implement instructions to the one or more implement actuators for articulation of the agricultural mower implement.

20. The implement arm system of claim 19, wherein the one or more vision sensors directed toward crops includes at least one of an optical sensor, a LiDAR sensor, a radar sensor, a laser sensor, ultrasonic height sensor, or a camera.

21. The implement arm system of claim 19, wherein the one or more vision sensors directed toward crops includes at least one of a vision sensor directed toward terrain proximate to crops or a vision sensor directed toward terrain beneath crops.

22. The implement arm system of claim 19, wherein at least one implement actuator of the one or more implement actuators includes an implement arm actuator coupled with an articulating arm, the implement arm actuator configured to move the agricultural mower implement relative to the prime mover with the articulating arm.

23. The implement arm system of claim 22 further comprising:
the articulating arm configured for coupling between the agricultural mower implement and the prime mover.

24. The implement arm system of claim 19, further comprising:
determine a difference between the location of the identified crops and a location of the agricultural mower implement; and
wherein the generated implement instructions include implement instructions for articulating the agricultural mower implement to decrease the difference.

25. The implement arm system of claim 24, wherein determining the difference includes determining a difference between a crop edge and a cutting end of the agricultural mower implement.

26. The implement arm system of claim 19, wherein the one or more implement actuators includes at least one of a sickle height actuator or a reel height actuator.

27. The implement arm system of claim 19, wherein at least one of the one or more vision sensors directed toward crops are directed rearward of at least one of the prime mover or the agricultural mower implement.

28. The implement arm system of claim 19, wherein at least one of the one or more vision sensors directed toward crops is directed forward of at least one of the prime mover or the agricultural mower implement.

29. The implement arm system of claim 19, wherein the controller, in communication with the sensor interface, is further configured to:
identify one or more terrain proximate to crops; and
determine one or more characteristics of the identified crops.

30. The implement arm system of claim 29, wherein the one or more characteristics of the identified crops includes at least one of an average height of the crops, a terrain height, a variety of the crops, a variety of the terrain, or a location of the terrain.

31. The implement arm system of claim 30, wherein the one or more implement actuators includes at least one of a sickle height actuator; and
wherein the sickle height actuator is configured to control a sickle height of a sickle coupled to the agricultural mower implement based on at least one of the average height of the crops, the terrain height, the variety of the crops, or the variety of the terrain.

32. The implement arm system of claim 29, wherein the one or more characteristics of the identified crops include an obstacle recognition.

33. The implement arm system of claim 32, wherein the controller, in communication with the sensor interface, is further configured to:
generate implement instructions based on the obstacle recognition, the implement instructions including instructions to autonomously adjust height of the agricultural mower.

34. The implement arm system of claim 19, wherein a remote operator may override the implement instructions.

35. The implement arm system of claim 19, wherein the location of the identified crops includes an alignment determination between a crop edge and a cutting end of the agricultural mower implement.

36. The implement arm system of claim 35, wherein the controller, in communication with the sensor interface, is further configured to:
generate implement instructions based on the alignment determination.

37. The implement arm system of claim 21, wherein the one or more vision sensors directed toward crops and terrain proximate to crops includes at least one of an implement arm sensor, a sickle height sensor, or a reel height sensor.

38. A method for autonomously articulating an agricultural mower implement arm of an agricultural mower implement comprising:
identifying one or more crops or terrain proximate to crops using one or more vision sensors, the one or more vision sensors directed toward crops and terrain proximate to crops;
determining one or more characteristics of the identified crops;
generating implement instructions according to the determined one or more characteristics of the identified crops; and
autonomously articulating the agricultural mower implement relative to a prime mover based on the generated implement instructions.

39. The method of claim 38, wherein the one or more vision sensors directed toward crops and terrain proximate to crops includes one or more vision sensors directed toward terrain beneath crops.

40. The method of claim 38, wherein the one or more vision sensors directed toward crops and terrain proximate to crops includes at least one of an optical sensor, a LiDAR sensor, a radar sensor, a laser sensor, or a camera.

41. The method of claim 38, wherein the one or more characteristics of the identified crops includes at least one of an average height of the crops, a terrain height, a variety of the crops, a variety of the terrain, obstacle identification, or a location of the crops.

42. The method of claim 38, wherein the one or more characteristics of the identified crops include a location of the crops;
comprising determining a difference between the location of the crops and a location of the agricultural mower implement; and
wherein the generated implement instructions include implement instructions for articulating the agricultural mower implement to decrease the difference.

43. The method of claim 42, wherein determining the difference includes determining a difference between a crop edge and a cutting end of the agricultural mower implement.

44. The method of claim 43, comprising autonomously controlling a sickle height of a sickle coupled with the agricultural mower implement, controlling the sickle height is based on at least one of the one or more characteristics of the identified crops, the one or more characteristics of the identified crops including an average height of the crops, a terrain height, a variety of the crops, or a variety of the terrain.

45. The method of claim 43, further comprising a remote operator overriding the implement instructions.

46. The method of claim 38, wherein the one or more characteristics of the identified crops or terrain includes an alignment determination between a crop edge and a cutting end of the agricultural mower implement.

47. The method of claim 46, further comprising:
generating implement instructions based on the alignment determination.

48. The method of claim 38, wherein identifying terrain proximate to crops includes an obstacle recognition.

49. The method of claim 48, further comprising:
generating implement instructions based on the obstacle recognition, the implement instructions including instructions to autonomously adjust height of the agricultural mower implement.

50. The method of claim 39, wherein the one or more vision sensors directed toward crops and terrain proximate to crops includes at least one of an agricultural mower implement arm sensor, a sickle height sensor, or a reel height sensor.

51. The method of claim 39, wherein at least one of the one or more vision sensors is directed forward of at least one of the prime mover or the agricultural mower implement.

52. The method of claim 38, wherein at least one of the one or more vision sensors is directed rearward of at least one of the prime mover or the agricultural mower implement.

53. The method of claim 52, further comprising:
detecting, with the at least one of the one or more vision sensors directed rearward, crops mowed errantly located behind the agricultural mower implement.
